(19) United States
(12) Patent Application Publication
(10) Pub. No.: US 2020/0241700 A1
(43) Pub. Date: Jul. 30, 2020

(54) ENHANCED PROJECTED CAPACITIVE SENSING

(71) Applicant: AZOTEQ (PTY) LTD, Paarl (ZA)

(72) Inventors: Frederick Johannes BRUWER, Paarl (ZA); Daniel Barend RADEMEYER, Paarl (ZA)

(21) Appl. No.: 16/775,348

(22) Filed: Jan. 29, 2020

(30) Foreign Application Priority Data
Jan. 30, 2019 (ZA) 2019/00625

(51) Int. Cl. G06F 3/044; G06F 3/041

(52) U.S. Cl. CPC G06F 3/0445; G06F 2203/04112; G06F 3/0412; G06F 3/0416

(57) ABSTRACT

An enhanced projected capacitance sensing arrangement wherein electrically floating, transparent conductive material is located over or above a display to enhance or increase the distance or area over which projected or mutual capacitance measurements may be discernibly and measurably influenced by an object and wherein said material couples capacitively with mutual capacitance electrodes which are located around an edge of the display.

### CROSS-REFERENCE TO RELATED APPLICATION

The present application claims priority from South Africa application ZA 2019/00625, filed on Jan. 30, 2019, the contents of which is hereby incorporated by reference into this application.

### BACKGROUND OF THE INVENTION

Methods of using capacitance measurements to detect the proximity and/or touch of an object are known in the art. Inherent parasitic capacitances associated with sense plates, electrodes, switches, connections and wiring degrade performance in these applications. The same holds true for most other capacitance measurement applications. A specific capacitance measurement technique of importance is the “charge transfer method” of capacitance measurement. In this method the sense plate or antenna is charged and then discharged into a measurement circuit.

The charge transfer capacitance measurements can be further divided into surface capacitance and projected capacitance measurements techniques. Sense plate capacitance cancellation techniques are also known (see other patent applications by F J Bruwer et al) and result in substantially increased sensitivity that enables the user to perform functions based on proximity, touch and use sensor structures not considered or possible before.

Capacitive measurements can be used to determine a touch on a button or touch key or to determine a position of an object proximate to or touching a 2D surface in order to, for example, activate soft keys on a screen. To facilitate capacitive sensing over such screens or displays transparent conductors such as Indium Tin Oxide (ITO) are often used, typically with a so-called pig-tail to connect the ITO substrate to sensing and other circuitry. However, the use of such a pig-tail and ITO substrate, and associated connectors, may be cost prohibitive for high volume consumer electronic applications which are highly cost sensitive, for example wearable devices such as fitness trackers.

The present assignee has previously (circa 2012) publicly disclosed one possible solution which does not require such a pig-tail ITO substrate to sense activation of soft-keys displayed by a screen. In said disclosed solution, projected capacitance sensing electrodes are located around the edge or periphery of the screen, and project electric fields into the 2D area lying over said screen. When a user's finger, or another object, enters the 2D area, or comes close to it, it may perturb the electric fields of one pair of the sensing electrodes more than that of the others, which may allow detection of the finger position and by extension, which soft key is being activated.

FIG. 1 illustrates a typical application of the previously disclosed solution. A screen 1.1, for example an LCD, has six projected capacitance sensing electrode pairs Rx0, Tx0 to Rx5, Tx5 around its edge or periphery. That is, each projected capacitance sensing electrode pair comprises a receiver electrode, e.g. Rx0 and a transmit electrode, e.g. Tx0, as is known in the art. The electric fields of each projected pair may project into the 2D space above or over screen 1.1 as typically shown at 1.2. As such, areas 1.3 to 1.8 may be used to implement soft keys with said screen, with a user's finger, or other object, which perturb said electric fields within these areas, causing a discernible change in the measured capacitance of each projected electrode pair. A driven shield or ground member may be located over the electrode pairs, for example under a screen bezel or frame to ensure that user touches outside said screen do not cause appreciable change in the projected capacitance measured for electrode pairs.

Another application of the previously disclosed solution is depicted in FIG. 2. In this case the projected capacitance electrode pairs comprising Rx0, Tx0 to Rx5, Tx5 have the constituent electrodes positioned parallel to each other in a vertical sense, with the transmit electrodes closest to screen 2.1, as is evident from FIG. 2. Typically, during a no-touch period, electric fields would couple between each transmit or Tx electrode and its closest receive or Rx electrode, and not project much into the 2D space over screen 2.1. Driven shields or ground material may be used, similar to that described above, to ensure a user cannot easily engage a specific projected electrode pair by touching it from directly above or outside the 2D area of screen 2.1. However, when a user touches or comes close to areas 2.2 to 2.7, it may sufficiently influence the measured projected capacitance for each particular electrode pair for the event to be detected. This may depend on the driving characteristics of the circuitry connected to said transmit electrodes. In this manner, soft keys may be realized over screen 2.1 without the use of ITO or similar material.

It should be appreciated that in the foregoing examples depicted by FIG. 1 and FIG. 2, the positions of the transmit and receive electrodes may be interchanged without departing from the underlying concept of creating soft-keys over a screen or display through the use of projected capacitance electrode pairs at the edge or periphery of said screen.

FIG. 3 presents yet another application of the previously disclosed solution to realize soft keys over screen 3.1 without the use of an ITO substrate or similar. In this case, the projected capacitance electrode pairs are split to be located on two opposing edges of said screen, with Rx0 to Rx3 located on the left-hand side, and Tx0 to Tx3 located on the right. Consequently, the electric fields of each electrode pair, as typically depicted at 3.2 may couple right across screen 3.1, facilitating soft-key areas 3.3 to 3.6.

A number of drawbacks exist for the previously disclosed solution described above. For example it may be difficult to obtain a strong enough projected capacitance signal near the centre of the screen to allow use of a soft-key. The dimensions, design and material composition of the edge electrodes may be limited by the need to project electric fields far enough into said screen. Location of soft-keys within the 2D space may similarly be limited by the location of edge electrodes, with soft-keys typically aligned in the X or Y dimension with said electrodes. The following disclosure describing the present invention may address some of these disadvantages without requiring use of a pigtail connected ITO member, or similar.

### SUMMARY OF THE INVENTION

The present invention teaches use of electrically floating, transparent or substantially transparent conductive material, wherein said material may be located over or above a display or screen, to enhance or increase the distance or area over which projected or mutual capacitance measurements may be discernibly and measurably influenced by a user's finger, another body part, a stylus or another object. In an exemplary embodiment, said floating, substantially transparent conductive material, e.g. ITO, silver nano-wires, conductive mesh or PEDOT material, may couple capacitively with a limited number of a plurality of electrodes used for said mutual capacitance measurements, for example with one of two capacitive sensing electrodes, wherein the projected capacitances for the electrodes are measured or monitored in some manner. In a preferred embodiment, the mutual capacitance electrodes are located around the edge or periphery of a screen or display, similar to that discussed during the Background of the present disclosure. The screen or display may be an LCD or OLED display, for example.

By enhancing or increasing the distance or area over which mutual capacitance of edge electrodes may be influenced, it may be possible to realize more or improved soft-keys over the screen or display without requiring a connection or so-called pigtail to the floating conductive material, e.g. to the ITO overlaid onto said screen. Alternatively, if the mutual capacitance edge electrodes are used to detect X and Y coordinates of a user touch or proximity event on a screen, display or other 2D area, the teachings of the present invention may be used to improve the linearity, resolution and accuracy with which said X and Y coordinates are reported. This may, for example, be used to improve the accuracy with which left-to-right, right-to-left, up-down and down-up swipes, or swipes in another direction or pattern, are detected.

In another embodiment of the invention, additional dummy sections of substantially transparent, electrically floating and conductive material may be located over the screen or display to improve the uniformity of transparency as perceived by a user. In other words, additional sections of floating material such as ITO may be placed alongside the floating conductive material which couple capacitively with the mutual capacitance electrode or electrodes, wherein said additional sections may help avoid a screen or display which seems to have dots, lines or spots.

The present invention further teaches that electrically floating, transparent or substantially transparent and conductive material may be used to ease or reduce constraints on the placement of edge electrodes, wherein said edge electrodes may be located on the edge of a screen or display, for example. The floating conductive material may be used to capacitively couple to a user's finger, other appendage, a stylus or another object at a specific location over said screen, and to also couple capacitively to at least one of a number of mutual capacitance electrodes, wherein said electrodes may then be placed with more freedom. In other words, the substantially transparent, floating conductive material may be used to connect a first pad or section, wherein the first pad or section may couple capacitively with a user's finger at a specific location over the screen, and a second pad or section, wherein the second pad or section may couple capacitively with at least one of a number of electrodes for which the mutual capacitance may be measured and/or monitored.

In another exemplary embodiment of the present invention, an array of touch or proximity keys may be formed over a display or screen by using sections of electrically floating transparent, or substantially transparent and conductive material to capacitively couple specific areas of the 2D space over said screen to specific mutual capacitance edge electrodes.

In another exemplary embodiment the members may be any (also non-transparent) conductive material that forms a capacitive coupling with an electrode of an electrode pair in order to enlarge or move the sensing area. For example, the housing of a wearable unit may have a conductive area that does not make electrical contact with the electrode or the user, but still enlarges the measured capacitive deviation when the wearable is worn by a user.

This technique described may also be applied to other capacitive measurement techniques e.g. self-capacitive measurements in order to improve performance, or to lower costs. Essentially the requirement for electrical contact is reduced.

### BRIEF DESCRIPTION OF THE DRAWINGS

The invention is further described by way of examples with reference to the accompanying drawings in which:

FIG. 1 shows a top view of a prior art mutual capacitance edge electrode application to realize soft keys around the edge of a 2D display.

FIG. 2 shows a top view of another prior art mutual capacitance edge electrode application to realize soft keys around the edge of a 2D display.

FIG. 3 shows a top view of a prior art mutual capacitance edge electrode application to realize soft keys over a central part of a 2D display.

FIG. 4 shows top and side views of an exemplary embodiment of the present invention to enhance the distance and/or area of projected capacitance sensing for edge electrodes alongside a 2D display.

FIG. 5 shows a top view of another exemplary embodiment of the present invention to enhance the distance and/or area of projected capacitance sensing for edge electrodes alongside a 2D display.

FIG. 6 shows a top view of an exemplary embodiment of the present invention to improve the uniformity of images displayed by a screen.

FIG. 7 shows a top view of an exemplary embodiment of the present invention to ease location limits for the placement of edge electrodes.

FIG. 8 shows a top view of an exemplary nine key array utilizing the teachings of the present invention.

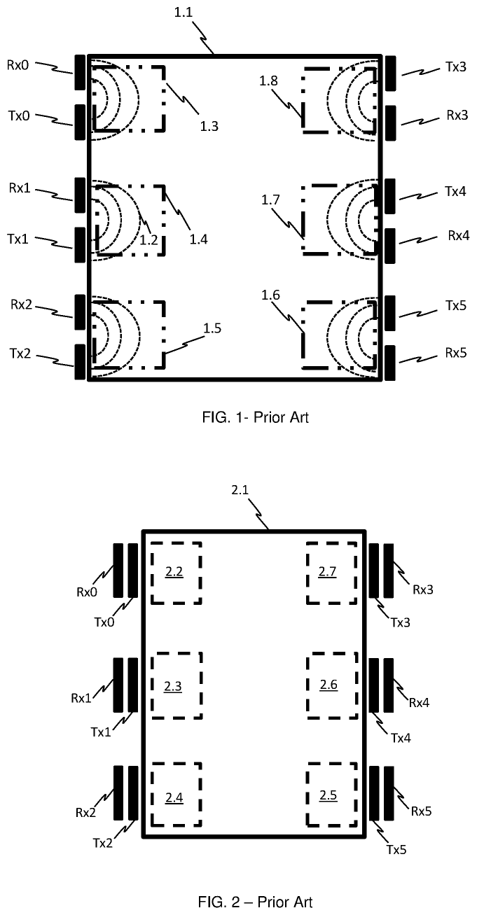

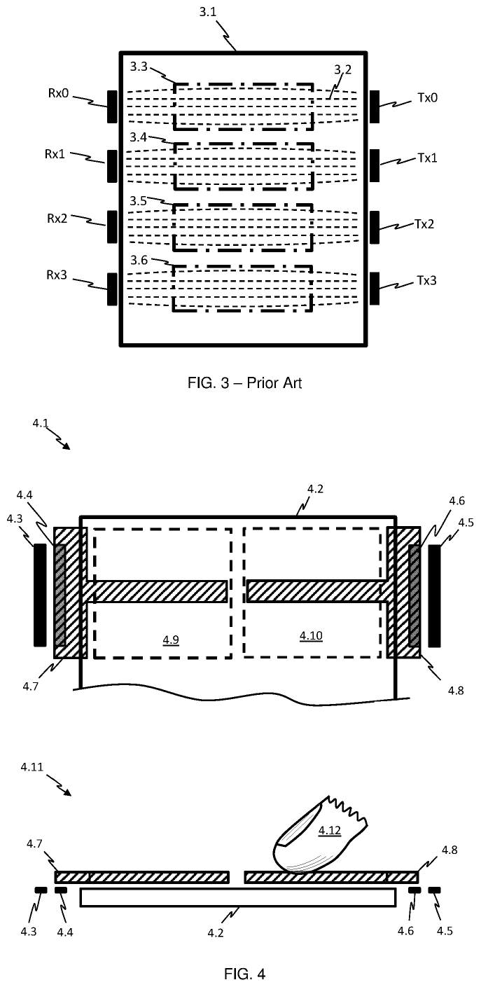

### DETAILED DESCRIPTION OF EMBODIMENTS

Disclosure of the present invention may be further aided by a detailed description of exemplary embodiments depicted in the appended drawings. It should be understood that both the drawings and the following description are not meant to limit the present invention, but merely to clarify its disclosure.

A first exemplary embodiment of the present invention is depicted at 4.1 and 4.11 in FIG. 4. Screen or display 4.2 has two pairs or projected or mutual capacitance electrodes, comprising electrodes 4.3, 4.4, 4.5 and 4.6, located alongside its left-hand and right-hand edges. The mutual capacitance for said electrodes may be measured by circuitry (not shown) to determine when and where a user touches or comes close to screen 4.2. For example, electrode 4.3 may be a first receive or Rx electrode, electrode 4.4 may be a first transmit or Tx electrode, electrode 4.5 may be a second receive or Rx electrode and electrode 4.6 may be a second transmit or Tx electrode, with said first Rx and Tx electrodes forming one mutual capacitance electrode pair and the second Rx and Tx electrodes forming a second mutual capacitance electrode pair. According to the present invention, the distance or area over which user touches or proximity events may be discerned may be enhanced or increased through the use of floating conductive material which couples with at least one of the electrodes of said electrode pairs. For example, members 4.7 and 4.8 may comprise substantially transparent material such as ITO, silver-nanowires, wire mesh or PEDOT, and may lie over and couple capacitively with Tx electrodes 4.4 and 4.6 respectively, while also extending into regions 4.9 and 4.10. A sectional side view of the embodiment is depicted at 4.11, also showing user finger 4.12. By extending the floating, conductive sections 4.7 and 4.8 into regions 4.9 and 4.10, the distance or area over which finger 4.12 may be detected is increased. For example, when finger 4.12 couples galvanically or capacitively to section 4.8 as depicted at 4.11, it effectively also couples capacitively to Tx electrode 4.6, which may cause a measurable change in the mutual capacitance for electrodes 4.6 and 4.5. It should be appreciated that electrodes 4.3 and 4.5 may also be used as Tx electrodes, and electrodes 4.4 and 4.6 as Rx electrodes without departing from the teachings of the present invention.

The X coordinate of a user finger touch on or proximity to screen 4.2 may therefore be determined with greater accuracy, resolution or linearity using the above described embodiment. A skilled reader should immediately note that the above is purely exemplary, and the invention may just as easily be used to determine Y coordinates by arranging the described members in a vertical or Y direction sense. The described embodiment may also be used to realize soft-keys over areas 4.9 and 4.10 of screen or display 4.2.

Further, the present invention teaches that additional X or Y information may be gleaned from mutual capacitance measurements by taking the resistive losses of the transparent or substantially transparent conductive material into account. For example, ITO may have a fairly high surface resistance characteristic, and this may variably influence the amount of coupling between a user's finger and one of the mutual capacitance edge electrodes, with said variation dependent on the ITO length and area between said finger and said one electrode. The present invention also teaches that the structure or design of said floating, transparent conductive material sections may be used to compensate for said resistive losses. For example, the horizontal part of a section such as 4.7 in FIG. 4 may have a width which increases towards the centre of screen 4.2.

In a related embodiment, members 4.7 and 4.8 may be fashioned to be one member connected centrally. In other words, the two horizontal arms of members 4.7 and 4.8 may be increased in length towards the middle of screen 4.2, in a vertical sense, until they form one horizontal arm across areas 4.9 and 4.10. Due to resistive losses in the material of said arm, the X-coordinate of a touch or proximity may be measured or determined with high accuracy with such a single horizontal arm. That is, when members 4.7 and 4.8 are extended towards the centre until they touch, a touch on one side may potentially be measured with higher accuracy due to the conductive path with resistive losses of the single horizontal arm so formed. In this embodiment it may be beneficial to perform a differential measurement, i.e. to have the two electrode pairs measured synchronously. According to the present invention, capacitive sensing electrodes 4.4 and 4.6 may also be connected electrically for such an embodiment, although the invention is certainly not limited to this option only. When members 4.7 and 4.8 are connected together as described, a touch or proximity event may be discerned from the signals measured for the mutual capacitance electrodes on both sides of said screen, that is at both electrodes 4.3 and 4.5, for example, thereby increasing signal-to-noise ratios and/or accuracy. When said members are not centrally connected, a touch needs to be over both, i.e. in the middle between areas 4.9 and 4.10, for both mutual capacitance electrode pairs to typically register said touch.

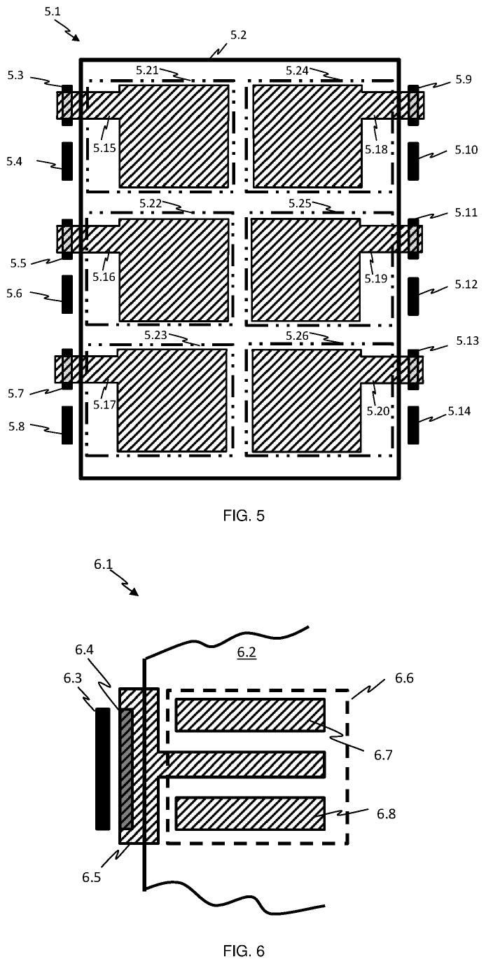

FIG. 5 presents another exemplary embodiment at 5.1, with screen 5.2 having a plurality of edge electrodes 5.3 to 5.14 along its left and right-hand edges. Said electrodes may be used for mutual capacitance measurements, as is known in the art, with for example electrodes 5.3, 5.5, 5.7, 5.9, 5.11 and 5.13 being transmit or Tx electrodes and electrodes 5.4, 5.6, 5.8, 5.10, 5.12 and 5.14 being receive or Rx electrodes. It is to be appreciated that the electrodes may also be interchanged in terms of being a Tx or Rx electrode. The mutual capacitance electrode pairs are 5.3 and 5.4, 5.5 and 5.6 and so forth. According to the present invention the effective sensing area for each electrode pair may be enhanced or increased to substantially cover each of areas 5.21 to 5.26 respectively by using electrically floating, transparent and conductive material sections 5.15 to 5.20 to capacitively couple each of said areas to its respective Tx electrode, wherein said transparent sections also lie over each respective transmit electrode as illustrated. For example, floating, transparent conductive section 5.15 may couple capacitively to Tx electrode 5.3, and due to its conductive nature and design or dimensions, also couple most of area 5.21 to electrode 5.3. An embodiment as shown at 5.1 may advantageously be used if a number a discrete soft-keys or buttons needs to be realized over screen 5.2. However, it may not work as well if X and Y coordinates need to be measured, since each of the floating conductive sections cover a relatively large area of the screen. In such a case, it may be beneficial to make use of thinner lines of floating conductive material, similar to that shown in FIG. 4.

Display uniformity is always important in today's competitive consumer electronics and other markets. Realization of a number of ITO or similar lines over a screen or display with large areas without ITO between them may negatively influence display uniformity. According to the present invention, this may be overcome with an exemplary embodiment as shown at 6.1 in FIG. 6, where a section of a screen or display 6.2 is depicted, with edge electrodes 6.3 and 6.4 and a floating, transparent and conductive section 6.5 similar to that disclosed above. In addition, two unconnected dummy sections 6.7 and 6.8 are included within area 6.6, wherein said dummy sections are manufactured from the same or similar material than section 6.5, for example from ITO. This should improve the uniformity of display for the screen 6.2, while still allowing Y-coordinate information to be retrieved for touch or proximity events within area 6.6. As before, a skilled reader will note that the invention need not be limited to detection of Y-coordinates in the directly preceding, and may equivalently be practised to extract X-coordinate information while maintaining display uniformity.

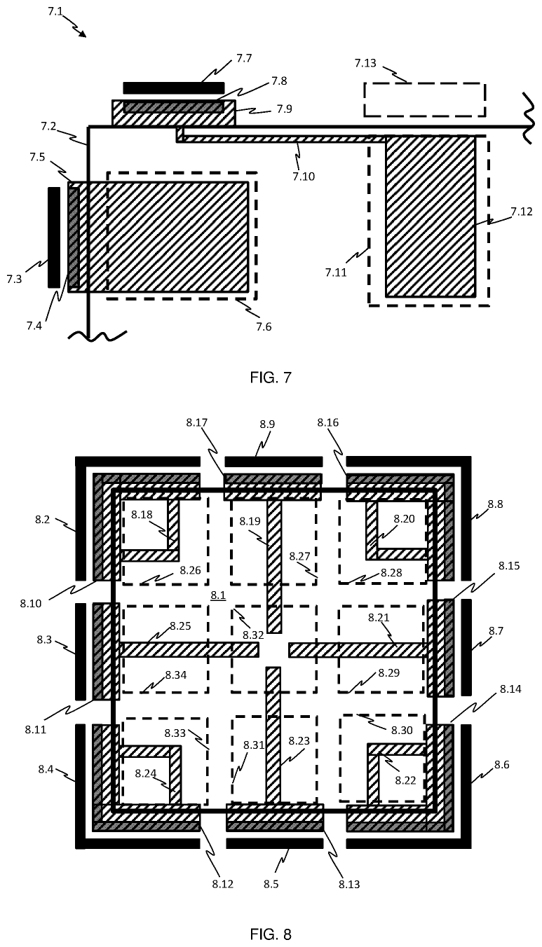

FIG. 7 presents yet another exemplary embodiment of the present invention at 7.1 which may be utilized to ease constraints on the placement or location of edge electrodes. A screen or display 7.2 may have a plurality of projected capacitance electrodes 7.3, 7.4, 7.7 and 7.8 located on its edge or periphery, with electrodes 7.3 and 7.4 forming one TxRx pair and electrodes 7.7 and 7.8 forming another. For example, electrodes 7.3 and 7.7 may be used as receiver or Rx electrodes and electrodes 7.4 and 7.8 as transmitter or Tx electrodes, or vice versa. Circuitry (not shown) connected to these electrodes may be used to perform mutual capacitance sensing and thereby determine XY coordinates of user interaction such as touch or proximity events, for example within areas 7.6 and 7.11. As depicted, an electrically floating, transparent and conductive member 7.5, for example fashioned out of ITO, may be placed over electrode 7.4 to facilitate sensing of user interaction within area 7.6, similar to that described earlier in the present disclosure. To sense user interaction within area 7.11 a designer might want to locate edge electrodes within area 7.13. However, due to the one or other constraint, for example routing of electrical conductors, noise source location, thermal considerations etc., locating electrodes within area 7.13 may not be practical or possible. According to the present invention, this limitation may be overcome through the use of electrically floating, conductive and transparent sections 7.9, 7.10 and 7.12, for example fashioned out of ITO, in the manner shown. Section 7.9 may couple capacitively with electrode 7.8 due to its location over said electrode. Section 7.10 may be used to connect section 7.9 to section 7.12, allowing a user touch or proximity event within area 7.11 to be relayed, so to speak, to section 7.9 and thereby to electrode 7.8. In this manner, edge electrodes 7.7 and 7.8 may be placed with less constraints while still allowing detection of user interaction within area 7.11 without requiring a direct connection or pigtail to the transparent, floating and conductive material, for example ITO, situated over screen 7.2.

Yet another exemplary embodiment of the present invention is presented in FIG. 8. A screen or display 8.1 is surrounded by a number of edge electrodes 8.2 to 8.17, which may be used for projected capacitance measurements with circuitry (not shown) connected to said electrodes. For example, electrodes 8.2 to 8.9 may be used as receiver or Rx electrodes and electrodes 8.10 to 8.17 as transmitter electrodes, or vice versa. Similar to that described earlier during the present disclosure, electrically floating, conductive and transparent or substantially transparent material may be located or placed over screen 8.1 to facilitate detection of user interaction over or on sections 8.26 to 8.34. For example, floating, transparent and conductive section 8.18 may be positioned over and couple capacitively with electrode 8.10, facilitating detection of user touch or proximity events within area 8.26. In a similar manner, floating, transparent and conductive sections 8.19 to 8.25 may be located over and couple capacitively with electrodes 8.17, 8.16, 8.15, 8.14, 8.13, 8.12 and 8.11 respectively to facilitate detection of user interaction within or over areas 8.27 to 8.31, 8.33 and 8.34. Further, according to the present invention, floating conductive sections 8.19, 8.21, 8.23 and 8.25 may be lengthened towards the centre of screen or display 8.1. This may enable detection of user touch or proximity events, or other interactions, within or over area 8.32 by monitoring for the same or a similar change in measured mutual capacitance at the four edge electrode pairs coupled to said floating sections.

1. A user interface comprising mutual capacitance electrode pairs, a display and electrically floating, conductive and transparent or substantially transparent first members, wherein said members are located over a viewing area of said display and over at least one electrode of said electrode pairs, with said electrode pairs located along an edge or periphery of said display outside the viewing area of the display, wherein said members couple selectively and capacitively to distinct electrodes of said mutual capacitance electrode pairs, said user interface allowing a user touch or proximity event that occurs over or within the viewing area of said display to cause a discernible change in the mutual capacitance value measured for a specific one of said electrode pairs.

2. The user interface of claim 1, wherein a first member of said memebers is positioned across the display and forms capacitive couplings with at least an electrode from two transmitter/receiver pairs.

3. The user interface of claim 2, wherein the two transmitter/receiver pairs are measured synchronously.

4. The user interface of claim 1, wherein self-capacitance measurements are performed and a single electrode is used, and a first member of said members has a capacitive coupling with at least one self-capacitive measurement electrode.

5. A user interface comprising mutual capacitance electrode pairs, and electrically floating, conductive first members, wherein said members are located over a viewing area and over at least one electrode of said electrode pairs, with said electrode pairs located along an edge or periphery of said viewing area outside the viewing area wherein said members couple selectively and capacitively to distinct electrodes of said mutual capacitance electrode pairs, said user interface allowing a user touch or proximity event that occurs over or within the viewing area of said display to cause a discernible change in the mutual capacitance value measured for a specific one of said electrode pairs.

6. An enhanced projected capacitance sensing arrangement wherein electrically floating, conductive material is located over or above a viewing area to enhance or increase the distance or area over which projected or mutual capacitance measurements may be discernibly and measurably influenced by an object and wherein said material couples capacitively with mutual capacitance electrodes which are located around and outside an outside edge of the viewing area
